(19) United States
(12) Patent Application Publication
(10) Pub. No.: US 2020/0341625 A1
(43) Pub. Date: Oct. 29, 2020

(54) AUTOMATED CONFERENCE MODALITY SETTING APPLICATION

(71) Applicant: MICROSOFT TECHNOLOGY LICENSING, LLC, Redmond, WA (US)

(72) Inventors: Dominic ROEDEL, Prague (CZ); Philipp STEINACHER, Prague (CZ); Marek CAIS, Prague (CZ); Ewin Davis KANNUTHOTTIYIL, Prague (CZ); Mario NOVOSELEC, Prague (CZ)

(73) Assignee: MICROSOFT TECHNOLOGY LICENSING, LLC, Redmond, WA (US)

(21) Appl. No.: 16/396,595

(22) Filed: Apr. 26, 2019

(51) Int. Cl. G06F 3/0484; H04N 7/15

(52) U.S. Cl. CPC G06F 3/04847; H04N 7/15

(57) ABSTRACT

In a device including a processor and a memory in communication with the processor, the memory includes executable instructions that, when executed by the processor, cause the processor to control the device to perform functions of storing a first modality setting for configuring conferencing-related operations of the device; receiving, from a user via a user interface, a first user input indicating an intention to join a first conference; determining whether the first modality setting is relevant to the first conference based on an attribute of the first conference; and when it is determined that the first modality setting is relevant to the first conference, allowing the user to join the first conference using the first modality setting. The device thus allows the user to join the conference without needing to adjust a modality setting and worrying about how he or she would be seen or heard by other participants.

### BACKGROUND

Video conferencing technologies have become increasingly commonplace. Such technologies are now being used worldwide for a wide variety of both personal and business communications. For example, during a teleconference or other video conferencing session, individuals may interact and engage in face-to-face conversations with other participants through images and sound captured by various audiovisual capturing devices and transmitted to participants. While the current technologies can provide blazingly fast data transmission and processing speeds necessary for a real-time audiovisual communication, participants have no easy way to know whether they are seen and heard by other participants without any problems. Hence, when a participant is connected to a videoconferencing, the first thing he or she may do is to ask other participants whether they can see and hear him or her without difficulties. When the participant learns that others cannot see or hear him or her properly, then the conference may be paused until the participant finds what causes the problems and fixes the problems. Also, while participants can adjust the audiovisual setups before joining a videoconferencing session, they are not certain as to how their appearances, voices and/or environments are being represented to other participants. As such, there still remain significant areas for new and improved implementations for more streamlined videoconferencing user experiences.

### SUMMARY

A device includes a processor and a memory in communication with the processor. The memory includes executable instructions that, when executed by the processor, cause the processor to control the device to perform functions of storing a first modality setting for configuring conferencing-related operations of the device; receiving, from a user via a user interface, a first user input indicating an intention to join a first conference; determining whether the first modality setting is relevant to the first conference based on an attribute of the first conference; and when it is determined that the first modality setting is relevant to the first conference, allowing the user to join the first conference using the first modality setting.

In another implementation, a method of operating a device includes storing a first modality setting for configuring conferencing-related operations of the device; receiving, from a user via a user interface, a first user input indicating an intention to join a first conference; determining whether the first modality setting is relevant to the first conference based on an attribute of the first conference; and when it is determined that the first modality setting is relevant to the first conference, allowing the user to join the first conference using the first modality setting.

In another implementation, a device includes a processor and a memory in communication with the processor. The memory includes executable instructions that, when executed by the processor, cause the processor to control the device to perform functions of receiving, from a first remote device via a communication network, an indication to join a first conference; retrieving, from a data storage, a first modality setting for configuring conferencing-related operations of the first remote device in relation to the first conference, the first modality setting associated with an attribute of the first conference; sending the first modality setting to the first remote device via the communication network; and allowing a first user of the first remote device to join the first conference using the first modality setting.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 illustrates an implementation of a conferencing system.

FIG. 2 illustrates an implementation of a graphical user interface for setting up a modality setting.

FIG. 3 illustrates an implementation of a graphical user interface for providing join options, which is part of the modality setting shown in FIG. 2.

FIG. 4 illustrates a flow diagram showing operations by a user device implemented to allow a user to set up a modality setting and join a conference using the modality setting.

FIG. 5 illustrates a flow diagram showing operations by a user device implemented to allow a user to join a conference using an automatically selected modality setting.

FIG. 6 illustrates a flow diagram showing operations by a conference server implemented to allow a user to join a conference using an automatically selected modality setting.

FIG. 7 is a block diagram showing an example computer system upon which aspects of this disclosure may be implemented.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

This description is directed to allowing a user to join a conference using a modality setting optimized or personalized for a conference. A modality setting may refer to a configuration of conferencing-related operations or functions of a conference device or system. A modality setting may be set up by a user or a conference organizer and stored in data storage. When the user wants to join a conference, it may be determined whether the modality setting is relevant to the conference. When the modality setting is relevant to the conference that the user wants to join, the modality setting may be automatically applied when the user joins the conference. With the optimized modality settings, the user may join a conference without worrying about whether he or she can be seen and heard by other participants. This may allow the conference to commence immediately when the participants join the conference. The modality setting may also allow the user to determine how he or she should be seen and heard by other participants. Hence, the user may participate in the conference with less uncertainty and anxiety as to how he or she would be presented to other participants. The modality setting may be centrally managed by a conference server or cloud system such that every participant joins the conference using the same modality setting. This may allow the conference to commence immediately without needing to notify every participants how their modality setting should be set up and waiting for every participants to adjust their modality settings.

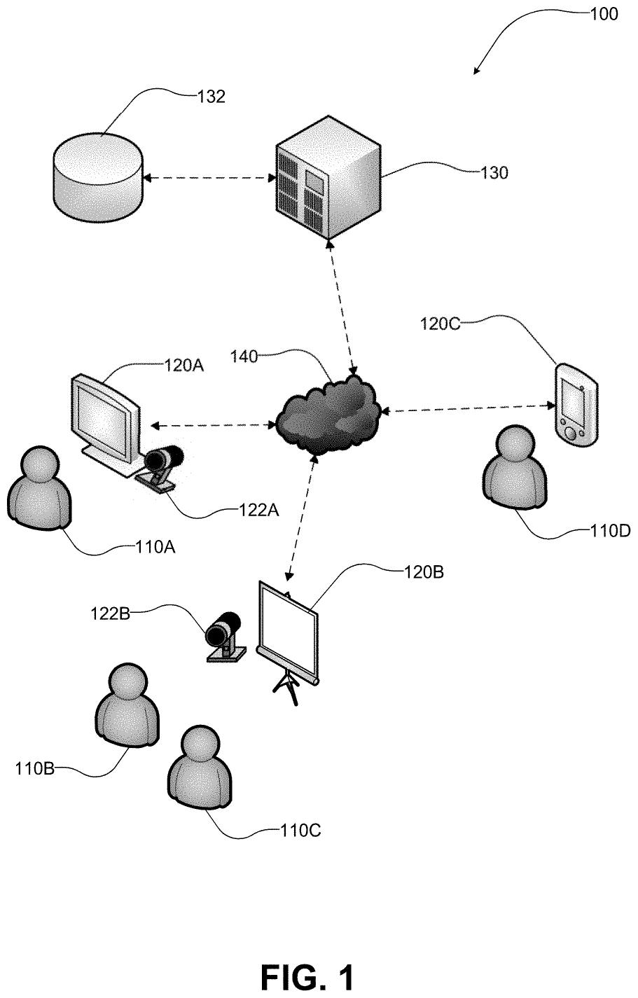

FIG. 1 illustrates an implementation of a conferencing system 100, configured to provide a conferencing service to a plurality of users, such as users 110A, 110B, 100C and 110D, which are concurrently referred to as users 110. The system 100 may include a plurality of user devices, such as user devices 120A, 120B and 120C, which are concurrently referred to as user devices 120. The user devices 120 may be connected to each other and to a conferencing server 130 via the Internet 140 or other type of communication network. The server 130 may include or be connected to a data storage 132.

The user devices 120 may be any type of computing device with audio or video communication capabilities, such as a desktop computer, laptop computer, mobile phone, tablet PC, projector, conferencing terminal, etc. For example, the user device 120A may be a desktop PC connected to a separate image capturing device 112A for capturing an image of the user 110A. The user device 120A may also be connected to an external microphone to capture a voice of the user 110A. The user device 120A may include a display and speakers to reproduce the image and sound captured by a different user devices and sent to the user device 120A. The user device 120B may be a projector, which may be located in a conference room, in which more than two users, such as users 110B and 110C, are congregated. The projector 120B may be equipped with or connected to audio and video devices, such as, a camera 112B, to capture an image and sound of the users 110B and 110C. The user device 120C may a smartphone equipped with integrated image and sound input and output devices, such as, a camera, microphone, display and speaker. As such, the user devices 120 may have different configurations and capabilities, which may be complemented by additional devices such as a camera, microphone, speakers, etc.

The conferencing server 130 may configured to host or coordinate a conference among the users 110. For example, the server 130 may be configured to support various types of conferences among the users 110, such as an audiovisual conference, video only conference, audio only conference, text only conference, etc. The server 130 may also be configured to provide additional services for the conferences, such as media sharing or text message services. For example, the conferencing server 130 may allow the users 110 to exchange an image or audio file or text message while participating in an audiovisual, video only or audio only conference. The server 130 may have access to the data storage 132, which may store various attributes related to conferences and users, such as, a conference ID, conference series ID, user identification and authentication, user preferences, user device configuration, modality settings, etc.

The server 130 may also store, for example, in the data storage 132, one or more modality settings, which may be provided to the user devices 120 or centrally enforced by the server 130. Each modality setting may be associated with one or more attributes of the conference or user, such as, a conference identification, conference participants, conference type, conference date, time and duration, user identification, user location, etc. The conference identification may include a unique conference ID or conference series ID, which are typically generated by the server 130. The conference participants may include a list and IDs of the conference participants or invitees. The conference type may indicate whether the conference is a structured, ad-hoc, scheduled, or broadcast conference.

The user devices 120 may store, in the data storage 132, one or more modality settings, each associated with one or more attributes of the conference or user, such as, a conference identification, conference participants, conference type, conference date, time and duration, user identification, user location, etc. For example, the user devices 120 may store two different modality settings for two different conference series having two different participant groups, respectively. Alternatively, the user devices 120 may include two different modality settings for different user locations, for example, when the user is joining the conference from his or her office and home, respectively.

The user device 120 may also be configured to allow the users 110 to set up a new modality setting or modify the existing modality setting to create a new modality setting, which may be stored in the data storage for later use. Using the user devices 120, the users 110 may set up a modality setting optimized or personalized for a conference having a particular attribute, such as, a conference identification, conference participants, conference type, user identification, user preferences, user location, user schedule, user device hardware/software configuration, network connection quality, etc.

The user devices 120 may be configured to automatically retrieve and apply a modality setting for a conference. The user devices 120 may also be configured to allow the users 110 to switch to a different modality setting while the conference is commencing. The user devices 120 may also monitor various parameters (e.g., a number of participants, participants' locations, network condition, etc.) of an on-going conference to determine and then automatically switch from one modality setting to another when a trigger condition is met and. For example, when a conference is started, an “ice-break” modality setting may be applied to allow the participants to see and talk to each other until a predetermined percentage (e.g., 80%) of the participants have joined the conference. Once the predetermined percentage is reached, the modality setting may be changed from the “ice-break” modality setting to a “broadcast” modality setting such that only the main speaker of the conference may be seen and heard during the conference.

For another example, referring to FIG. 1, the mobile device 120C may be equipped with location detection capabilities, which may determine a geographical location of the mobile device 120C. For example, the mobile device 120C may include a GPS device that allows it to track its GPS coordinates. Alternatively or additionally, the mobile device 120C may be equipped with a wireless communications device, such as, a cellular, Wi-Fi or Bluetooth transceiver, to receive location information or conference information from a nearby base station, access point, location broadcasting device, etc. This may allow the mobile device 120C to receive location information or conference information, such as a room ID, conference ID, active conference notification, etc., when the mobile device 120C approaches or enters a conference room where the projector 120B, camera 122B, microphone or speakers connected to the server 130 are located and providing the video and/or audio content of the conference. When the user 110D enters such conference room, it may be no longer necessary for the mobile device 120C to enable all of the audio and video input and output capabilities. Hence, once the mobile device 120C determines that the user 110D is located at the conference room or when the mobile device 120C receives a conference room ID or active conference notification from a nearby broadcasting device, the mobile device 120C may switch to a “conference room” modality setting to deactivate some of the video and audio input and output capabilities. For example, the mobile device 120C may automatically deactivate the video output capabilities to stop showing the video content of the conference while still allowing the user 120C to hear the audio content of the conference. When there is a microphone connected to the server 130 in the conference room, the mobile device 120C may turn off its internal microphone. As such, the user devices 120 may be configured to switch from one modality setting to another when a trigger condition is detected.

The user devices 120 may also receive a modality setting from a remote device, such as, the conferencing server 130, another user device 120 or a cloud storage, and apply the received modality setting for a particular conference associated with a particulate conference attribute. This may allow the users 110 to join a conference without needing to set up or adjust a modality setting. Also, the conference organizer may not need to worry about different users 110 connecting to the conference with different modality settings. This might be useful when the conference is a presentation or lecture and the conference organizer wants the microphones at the user devices 120 turned off when the conference starts. Since the users 110 are connected to the conference with their microphone turned off or audio input device deactivated, the conference may commence without needing to worry about the users 110 making noises or interrupting the presentation or lecture. The modality setting, however, may be configured to allow the users 110 to send and receive text messages.

The user 110 may set up a personalized modality setting for a specific conference or situation. The user device 120 may be configured such that a current modality setting is scrubbed and overridden by a pre-defined modality setting when the user 110 is trying to join a conference which is relevant to the pre-defined modality setting. For example, the user 110 may setup a personalized modality setting to turn off audio and video output capabilities, which does not allow other participants to see or hear the user 110. When the user 110 tries to join a conference using the personalized modality setting, the user device 120 may retrieve a pre-defined modality setting relevant to the conference, scrub the personalized modality setting and apply the retrieved modality setting when the user 110 joins the conference. Similarly, when there is a conflict between a centrally enforced modality setting and a user-selected modality setting, the user-selected modality setting may be automatically scrubbed and overridden by the centrally enforced modality setting.

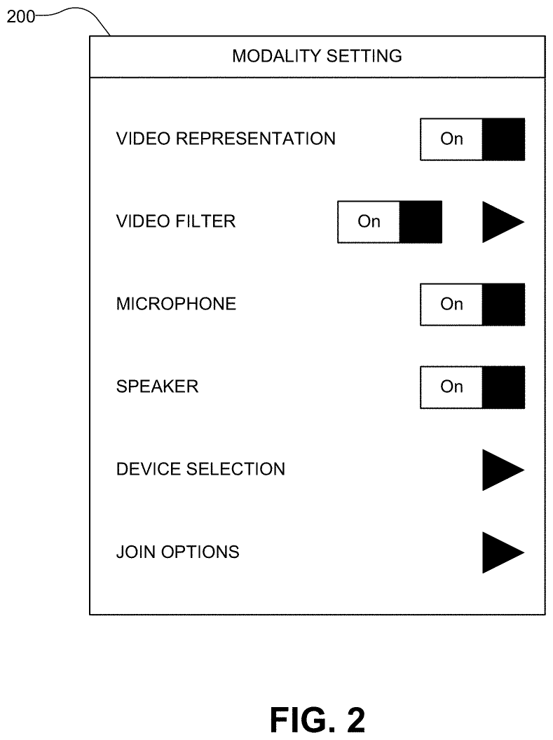

FIG. 2 illustrates an implementation of a modality setting graphical user interface (GUI) 200 for setting up a modality setting, which may be rendered by the user devices 120 and displayed on a display to allow the users 110 to set up a modality setting optimized or personalized for a particular user, user device, conference or conference type. The modality setting GUI 200 may also be used by a conference organizer to set up a modality setting for the conference he or she is in charge of organizing. The modality setting GUI 200 may include various modality settings, such as, whether a video representation is to be turned on or off, whether a video filter to be turned on or off, what kind of video filter to be used if a video filter is to be turned on, whether a microphone is to be turned on or off, whether a speaker is to be turned on or off, etc. The users 110 may turn on or off each setting using a user interface device, such as, a touch screen, keyboard, mouse, etc.

The modality setting setup GUI 200 may include additional setups, such as device selection, join options, etc. When the device selection is selected, the modality setting GUI 200 may generate another GUI that allows the user 110 to select a particular video device, audio device or a composite device, which is a combination of particular video and audio devices. For example, by using the device selection GUI, the user 110A may control the desktop PC 120A to display the video on the computer monitor while the sound is sent to a Bluetooth headset connected to the desktop PC 120A.

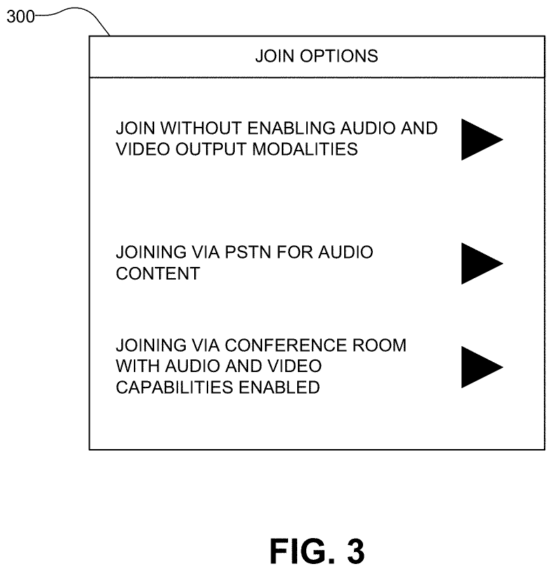

FIG. 3 illustrates an implementation of a join option GUI 300 configured to provide the user 110A with multiple join options, which may be part of the modality setting GUI 200 shown in FIG. 2. The user 110A may use the join options to set up a modality setting that is optimized for a particular conference attribute. For example, using the GUI 300, the user 110A may join a conference without enabling audio and video output modalities. This option may allow the user 110A to consume content of the conference without being seen or heard by other participants. The GUI 300 may also allow the user 110A to join a conference via a public switched telephone network (PSTN) for audio content while video content of the conference is sent and received via a packet-based network. The GUI 300 may also allow the user 110A to join a conference at a designated conference location while accessing audio and video content of the first conference via the user device 120A. Once one of the join options is selected by the user 110A, each setting in the modality setting GUI 200 may be overridden and adjusted to a new setting for the selected join option. Hence, by using the join options GUI 300, the user 110A may switch to a new modality setting without adjusting each individual settings at the modality setting GUI 200.

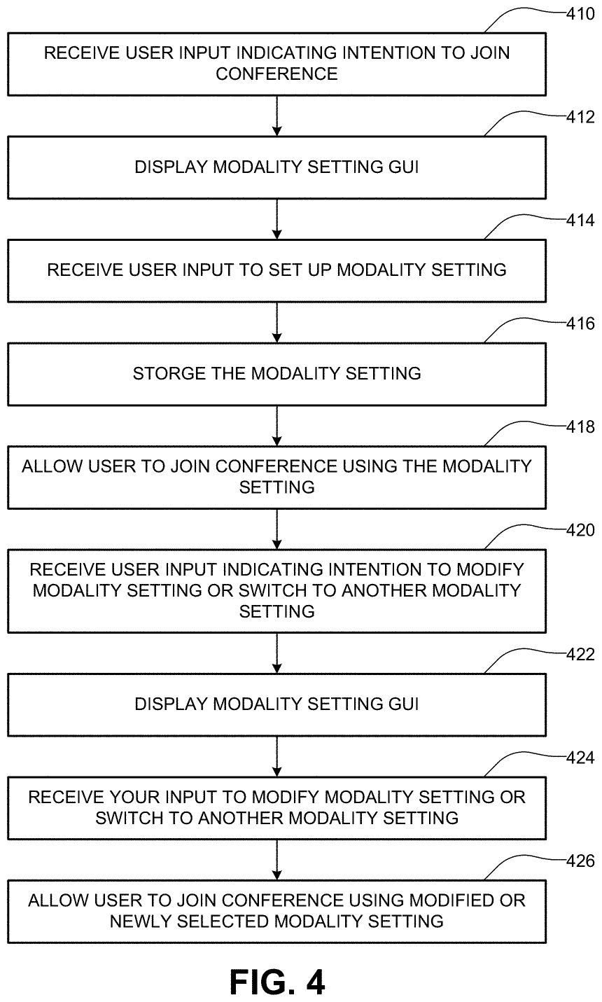

FIG. 4 illustrates a flow diagram showing operations by a user device (e.g., user device 120A) implemented to allow a user (e.g., user 110A) to set up a modality setting and join a conference using the modality setting. At step 410, the user device 120A may receive a user input from the user 110A indicating an intention to join a conference. The user 110A may indicate such intention in various ways. For example, the user 110A may click a conference join link in an email, conference invitation, calendar entry, conference reminder, conference notification, etc. Alternatively, the user 110A may click a link or an icon displayed on a conferencing application, or the conference may be deep-linked by a meeting protocol handler.

At step 412, upon receiving the user input at step 410, the user device 120A may not connect the user 110A to the conference immediately. Instead, the user device 120A may render and display a modality setting GUI, such as the modality setting GUI 200 shown in FIG. 2. For example, when the user 110A clicks a link in a conference invitation email or calendar entry, the user device 120A may active a conferencing application that may render a modality setting GUI. If such application is not installed, the user device 120A may open a web browser to allow the user 110A to access a modality setting web page.

At step 414, the user device 120A may receive, via the modality setting GUI 200, a user input to set up a modality setting for the conference he or she wants to join. For example, when the user 110A is at home and does not want to show the background behind him or her, the user 110A may adjust the modality setting to active a filter that blurs or covers the background of the user 110A when viewed by other participants. When the user 110A is joining a presentation or lecture, the user 110A may turn off the video and audio output capabilities of the user device 120A such that he or she is not seen or heard by other participants while the video and audio input capabilities of the user device 120A are turned on to allow the user 110A to see and hear the content of the conference.

In an implementation, once the user 110A indicates an intention to join a conference at step 410, the user device 120A may connect the user 110A to a pre-conference zone or lobby area where the user 110A is allowed to set up the modality setting for the conference. The pre-conference zone may be hosted by the conference server 130, which may communicate with the user device 120A to render and display the modality setting GUI 200 at the user device 120A at step 412. The user device 120A may then receive the user input to set up a modality setting 414 at step 414. The user device 120A may also communicate with the server 130 to determine whether the modality setting is acceptable for the conference and may provide a feedback if the modality is rejected by the server 130. The user 110A, however, may not need to go through the pre-conference zone if the modality setup is already in place and there is no need to set up a new modality setting or modify the exiting modality set up. Instead, the user 110A may be allowed to join the conference immediately upon indicating the intention to join the conference.

The user device 120A and conference server 130 may also communicate with each other to provide the user 110A with a feedback on how he or she would be seen and heard once the user 110A joins the conference using the modality setting. For example, when the user 110A has selected to turn on a video filter to hide the background, the user device 120A may display a video image of the user 110A applied with such video filter, which will be provided to other participants by the conference server 130. As such, while being connected to the pre-conference zone, the user 110A may be able to learn how he or she will be shown or heard by other participants once the user 110A joins the conference. If the user 110A does not like how he or she would be seen or heard by other participants, the user 110A may request the user device 120A to display the modality setting GUI 200 such that the user 110A may further adjust the modality setting.

At step 416, the user device 120A may store the modality setting in a data storage. Alternative or additionally, the modality setting may be sent to the conference server 130 and stored in the data storage 130. For example, when a conference application is installed in the user device 120A, the modality setting may be locally stored in the data storage of the user device 120A. The user device 120A may send the locally stored modality setting to the conferencing server 130, which may in turn save the received modality setting in the data storage 132. When the user device 120A is not installed with a conferencing application, the user device 120A may send the modality setting to the conference server 130, which may then save the received modality setting in the data storage 132.

The user device 120A and/or conference server 130 may associate the modality setting with one or more attributes of the conference or user, such as, a conference series identification, conference participants, user location, user schedule, user device hardware/software configuration, network connection quality, etc. This may allow the user device 120A to automatically retrieve and apply the stored modality setting when the user 110A joins another conference having the same or similar attribute. For example, when the user 110A sets up a modality setting for a series of conferences recurring regularly, the user device 120A may automatically retrieve and apply the modality setting when the user 110A joins one of the series of the conferences. The user 110A may also setup a modality setting associated with a group of particular users 110 such that the same modality setting is automatically applied to conferences involving the same group of users 110. Further, the user may set up a modality setting such that a video filter is turned on to hide the background when the user is at home after the normal office hours.

At step 418, the user device 120A may then allow the user 110A to join the conference using the modality setting set up by the user 110A. Since the user 110A has set up the modality prior to joining the conference and already knows how he or she would be seen or heard by other participants once the user 110A joins the conference, the user 110A may no longer need to ask other participants if they can see and hear the user 110A. Hence, the conference may commence immediately. Also, the user 110A may no longer need to be worried or concerned about how he or she would be represented to other participants.

At step 420, the user device 120A may receive a user input indicating an intention to modify the current modality setting or switch to another modality setting. For example, the user 110A may want to use a different sound output device to hear the audio content of the conference while the conference is commencing. The user 110A may also want to turn off the video filter or use a different video filter. The user 110A may then use the user interface (e.g., touch screen, mouse, keyboard, etc.) of the user device 120A to indicate the user's intention to modify the current modality setting or switch to another modality setting.

At step 422, the user device 120A may then render and display a modality setting GUI, such as the modality setting GUI 200 shown in FIG. 2. At step 424, the user device 120A may receive a user input to modify the current modality setting or switch to a new modality setting. At step 426, the user device 120A may then allow the user 110A to join the conference using the modified or newly selected modality setting. The steps 420, 422, 424 and 426 may be optional and may not need to be performed when the user 110A does not need to change the modality setting. In an implementation, the modality setting GUI 200 may be automatically activated when the user device 120 detects any malfunction by an audio or video device currently used for sending or receiving audio or video content of the conference.

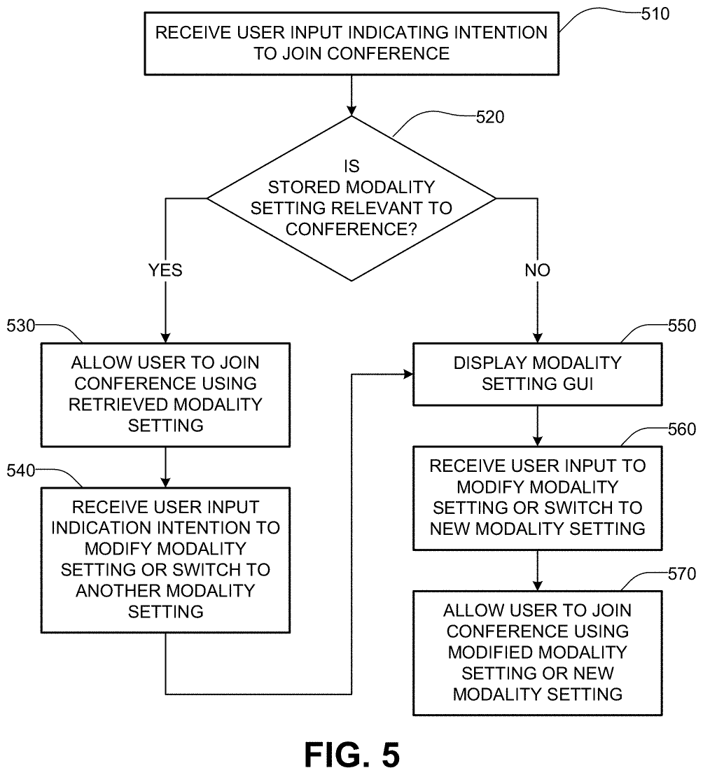

FIG. 5 illustrates a flow diagram showing operations by a user device (e.g., user device 120A) implemented to allow a user (e.g., user 110A) to join a conference using an automatically selected modality setting. The user device 120A may store a modality setting associated with a particular conference attribute, such as, a conference series identification, conference participants, user location, user schedule, user device hardware/software configuration, network connection quality, etc. The modality setting may be set up by the user 110A as described in FIG. 4, provided from another device, such as the conference server 130, other user devices 120, or downloaded form a cloud storage.

At step 510, the user device 120A may receive a user input from the user 110A indicating an intention to join a conference. For example, the user 110A may click a conference join link in an email, conference invitation, calendar entry, conference reminder, conference notification, etc.

At step 520, the user device 120A may determine whether the stored modality setting is relevant to the conference that the user 110A wants to join. Alternatively, the user 110A may manually determine that the conference is relevant to the stored modality setting, or such determination may be done by the conference server 130. The relevancy may be determined by comparing the attribute of the modality setting and the attribute of the conference. For example, when a modality setting is set up for a series of conferences recurring regularly, the user device 120A may automatically retrieve and apply the modality setting when the user 110A joins one of the series of the conferences. The user 110A may also setup a modality setting associated with a group of particular users 110 such that the same modality setting is automatically applied to conferences involving the same group of users 110. Further, the user may set up a modality setting such that a video filter is turned on to hide the background when the user is at home after the normal office hours. The modality setting may be also automatically selected and applied depending on a conference type, such as, structured, ad-hoc, scheduled, broadcast, etc. For example, when the conference is a broadcast type, the modality setting may be set up to disable all the audio and video input devices at the user devices 120 such that only the broadcasting party can be seen and heard during the conference. When a conference is an ad-hoc type, only the initiator of the conference can add participants to the conference, and the initiator may set up a universal modality setup that is automatically enforced when each participant joins the conference.

At step 530, the user device 120A may allow the user 110A to join the conference using the retrieved modality setting when it is determined that the stored modality setting is relevant to the conference (Yes at step 530). Since the stored modality setting and conference may have the same attribute, the retrieved modality setting may be optimized for the conference or personalized for the user 110A. Hence, the user device 120A may automatically apply the retrieved modality setting without any input from the user 110A. This may allow the user 110A to participate in the conference immediately without needing to check how he or she is seen and heard by other participants. The user 110A may already know how he or she would be presented when the retrieved modality setting is applied, which may reduce or eliminate any uncertainty or anxiety the user 110A may feel about how he or she would be presented to other participants.

At step 550, the user device 120A may render and display a modality setting GUI, such as the modality setting GUI 200 shown in FIG. 2 when it is determined that the stored modality setting is not relevant to the conference (No at step 530). The modality setting GUI 200 may be also rendered and displayed when the user 110A has joined the conference (at step 540) and the user device 120A receives a user input indicating an intention to modify the current modality setting or switch to another modality setting (at step 540).

At step 560, the user device 120A may receive, via the modality setting GUI 200, a user input to modify the current modality setting or switch to a new modality setting. When no relevant modality setting is available for the conference (No at step 530), the user device 120A may allow the user 110A to set up a new modality setting via the modality setting GUI 200.

At step 570, the user 110A may allow the user 110A to join the meeting using the modified modality setting or new modality setting. The steps 540, 550, 560 and 570 may not need to be performed when a relevant modality setting is available for the conference and the user 110A does not want to modify the automatically applied modality setting.

In an implementation, the user device 120A may store a plurality of modality settings that are associated with different conference attributes, respectively. Hence, when the user 110A indicates an intention to join a conference, the user device 120A may check whether any of the stored modality settings is relevant to the conference that the user 110A wants to join. When a relevant modality setting is found, the user device 120A may allow the user 110A to join the conference using the relevant modality setting, which may be automatically applied without any input from the user 110A. When the user 110A wants to join another conference having a different attribute, the user device 120A may apply a different modality setting if such modality setting relevant to the conference is available to the user device 120A. The modality settings may not be locally stored in the user device 120A. Instead, the modality setting may be stored and managed centrally by the conference server 130 and sent to the user device 120A when the user device 120A provides information on the conference that the user 110A wants to join.

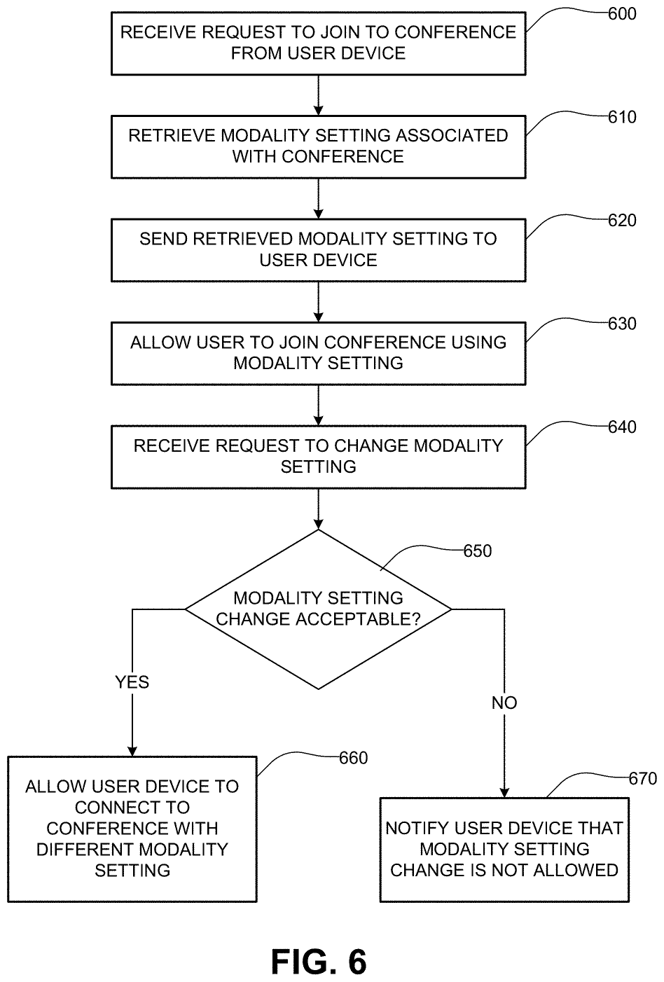

FIG. 6 illustrates a flow diagram showing operations by a device (e.g., conference server 130) implemented to allow a user (e.g., user 110A) to join a conference using an automatically selected modality setting.

At step 600, the conference server 130 may receive a request to join a conference from a user device (e.g., user device 120A) associated with the user 110A via the communication network 140. The conference may be hosted by the conference server 130.

At step 610, the conference server 130 may retrieve, for example, from the data storage 132, a modality setting associated with the conference requested by the user device 120A. The modality setting may be set up by a conference organizer. For example, the server 130 may allow the conference organizer to set up the modality setting using the modality setting GUI 200 shown in FIG. 2, which may be rendered and displayed at a user device of the organizer. The modality setting may be restrictive. For example, the modality setting may be set up such that all the user devices 120 are required to turn off the microphone when the users 110 are joining the conference. The modality setting may also be set up to turn on the video representation. Alternatively, the modality setting may be a personalized modality setting set up by the user 110A for conferences having a particular attribute and sent to the conference server 130.

At step 620, the server 130 may send the retrieved modality setting to the user device 120A via the communication network 140. Upon receiving the modality setting from the server 130, the user device 120A may request the server 130 to allow the user 110A to join the conference using the modality setting.

At step 630, the conference server 130 may then allow the user 110A to join the conference using the modality setting received from the conference server 130. In an implementation, the conference server 130 may communicate with the user device 120A to ensure that the user 110A joins the conference using the modality setting provided by the conference server 130. The conference server 130 may not allow the user to join the conference using a different modality setting. For example, when the conference is a presentation or lecture and the user 110A is one of a number of audiences, the modality setting may be set up such that the video representation and microphone are turned off to reduce the bandwidth required to transmit unnecessary image and voice data from the user device 120A to other user devices 120.

At step 640, the conference server 130 may receive a request to change the modality setting from the user device 120A, which may happen when the user device 120A detects any malfunctions in any of its audio and video devices or the user 110A wishes to remove a restriction in the modality setting set up by the conference organizer.

At step 650, the conference server 130 may determine whether the changes to the current modality setting requested by the user 110A is acceptable or not.

At step 660, the conference server 130 may allow the user device 120A to join the conference using a different modality when the changes to the modality setting requested by the user 110A is acceptable. For example, in a situation where the user 110A is an audience of a presentation or lecture, the user 110A may send a request to turn on the microphone. If the presentation or lecture is over, then the conference server 130 may allow the user device 120A to turn on the microphone such that the user 110A may ask a question or provide comments. If the present or lecture is not over yet, the conference server 130 may not allow the user 110A to change the current modality setting to turn on the microphone. Instead, at step 670, the conference server 130 may notify the user device 120A that the changes to the modality setting is not allowed. The steps 640, 650, 660 and 670 may not be performed when the user 110A does not need to change the modality setting, and hence may be optional.

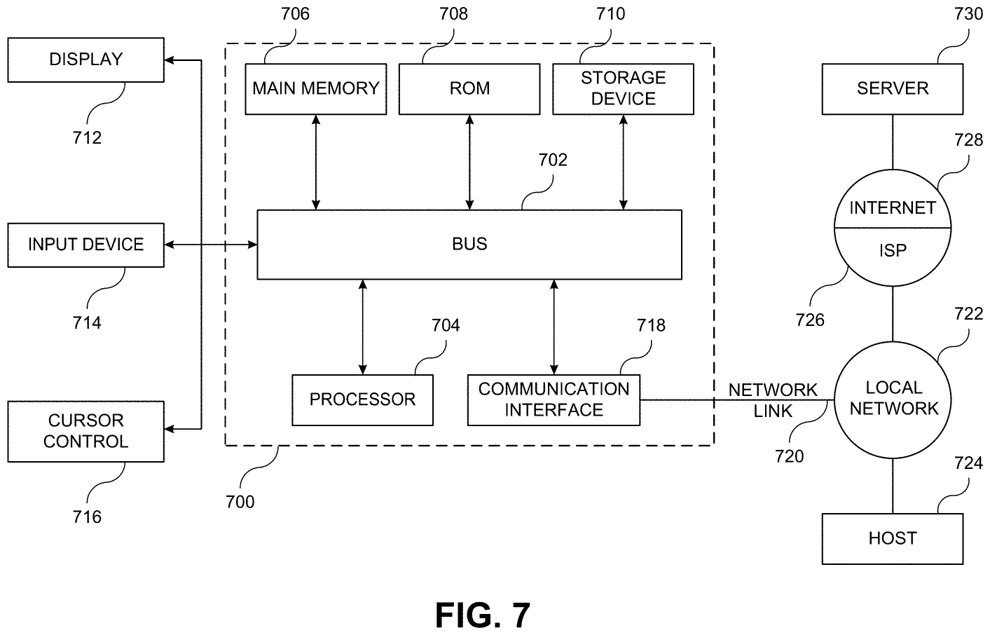

FIG. 7 is a block diagram showing an example a computer system 700 upon which aspects of this disclosure may be implemented. The computer system 700 may include a bus 702 or other communication mechanism for communicating information, and a processor 704 coupled with the bus 702 for processing information. The computer system 700 may also include a main memory 706, such as a random-access memory (RAM) or other dynamic storage device, coupled to the bus 702 for storing information and instructions to be executed by the processor 704. The main memory 706 may also be used for storing temporary variables or other intermediate information during execution of instructions to be executed by the processor 704. The computer system 700 may implement, for example, the user devices 120 and conference server 130.

The computer system 700 may further include a read only memory (ROM) 708 or other static storage device coupled to the bus 702 for storing static information and instructions for the processor 704. A storage device 710, such as a flash or other non-volatile memory may be coupled to the bus 702 for storing information and instructions.

The computer system 700 may be coupled via the bus 702 to a display 712, such as a liquid crystal display (LCD), for displaying information. One or more user input devices, such as the example user input device 714 may be coupled to the bus 702, and may be configured for receiving various user inputs, such as user command selections and communicating these to the processor 704, or to the main memory 706. The user input device 714 may include physical structure, or virtual implementation, or both, providing user input modes or options, for controlling, for example, a cursor, visible to a user through display 712 or through other techniques, and such modes or operations may include, for example virtual mouse, trackball, or cursor direction keys.

The computer system 700 may include respective resources of the processor 704 executing, in an overlapping or interleaved manner, respective program instructions. Instructions may be read into the main memory 706 from another machine-readable medium, such as the storage device 710. In some examples, hard-wired circuitry may be used in place of or in combination with software instructions. The term “machine-readable medium” as used herein refers to any medium that participates in providing data that causes a machine to operate in a specific fashion. Such a medium may take forms, including but not limited to, non-volatile media, volatile media, and transmission media. Non-volatile media may include, for example, optical or magnetic disks, such as storage device 710. Transmission media may include optical paths, or electrical or acoustic signal propagation paths, and may include acoustic or light waves, such as those generated during radio-wave and infra-red data communications, that are capable of carrying instructions detectable by a physical mechanism for input to a machine.

The computer system 700 may also include a communication interface 718 coupled to the bus 702, for two-way data communication coupling to a network link 720 connected to a local network 722. The network link 720 may provide data communication through one or more networks to other data devices. For example, the network link 720 may provide a connection through the local network 722 to a host computer 724 or to data equipment operated by an Internet Service Provider (ISP) 726 to access through the Internet 728 a server 730, for example, to obtain code for an application program.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it may be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

1. A device for automatically applying conference-related functionality settings to a user device, comprising:
a processor; and
a memory in communication with the processor, the memory comprising executable instructions that, when executed by the processor, cause the processor to control the device to perform functions of:
storing, in a data storage, a first modality setting comprising a plurality of first predetermined conference-related functionality settings applicable to a user device, the first modality setting corresponding to a first preset conference condition prescribing a conference attribute;
receiving a first user input indicating an intention of a user to join a first conference;
in response to receiving the first user input, determining, based on an attribute of the first conference and the prescribed conference attribute of the first preset conference condition, that the first conference meets the first preset conference condition;
in response to determining that the first conference meets the first preset conference condition, automatically causing the stored first modality setting to be applied to the user device; and
in response to the first modality setting being applied to the user device, causing the user to join the first conference using the user device applying the first modality setting.

2. The device of claim 1, wherein the instructions, when executed by the processor, further cause the processor to control the device to perform functions of:
receiving a second user input indicating an intention of the user to modify the first modality setting or switch to a second modality setting stored in the data storage;
in response to receiving the second user input, rendering a modality setting user interface;
receiving, via the modality setting user interface, a third user input to modify the first modality setting or switch to the second modality setting; and
in response to receiving the third user input, modifying the first modality setting or switching to the second modality setting.

3. The device of claim 1, wherein the instructions, when executed by the processor, further cause the processor to control the device to perform a function of receiving the first modality setting from a remote device via a communication network.

4. The device of claim 1, wherein the instructions, when executed by the processor, further cause the processor to control the device to perform functions of:
rendering, a modality setting user interface; and
receiving, via the modality setting user interface, a second user input to set up the first modality setting.

5. The device of claim 1, wherein the instructions, when executed by the processor, further cause the processor to control the device to perform functions of:
storing a second modality setting comprising a plurality of second predetermined conference-related functionality settings applicable to the user device, the second modality setting corresponding to a second preset conference condition prescribing another conference attribute;
receiving a second user input indicating an intention of the user to join a second conference;
in response to receiving the second user input, determining, based on an attribute of the second conference and the prescribed conference attributes of the first and second preset conference conditions, determining that the second conference meets the second preset conference condition;
in response to determining that the second conference meets the second preset conference condition, automatically causing the stored second modality setting to be applied to the user device; and
in response to the second modality setting being applied to the user device, causing allowing the user to join the second conference using the user device applying the second modality setting.

6. The device of claim 1, wherein the first modality setting defines at least one of:
whether a video representation is to be turned on or off;
whether a video filter is to be applied or not;
whether a microphone is to be turned on or off;
whether a speaker is to be turned on or off; and
which audio and visual devices are to be used.

7. The device of claim 1, wherein the first modality setting defines at least one of:
whether to join the first conference without enabling audio and video capabilities;
whether to join the first conference via a public switched telephone network (PSTN) for audio content of the first conference; and
whether to join the first conference at a designated conference location while accessing audio and video content of the first conference via the user device.

8. The device of claim 1, wherein the attribute of the first conference comprises at least one of a conference identification, conference participant and conference type.

9. A method of operating a device for automatically applying conference-related functionality settings to a user device, comprising:
storing, in a data storage, a first modality setting comprising a plurality of first predetermined conference-related functionality settings applicable to a user device, the first modality setting corresponding to a first preset conference condition prescribing a conference attribute;
receiving a first user input indicating an intention of a user to join a first conference;
in response to receiving the first user input, determining, based on an attribute of the first conference and the prescribed conference attribute of the first preset conference condition, that the first conference meets the first preset conference condition;
in response to determining that the first conference meets the first preset conference condition, automatically causing the stored first modality setting to be applied to the user device; and
in response to the first modality setting being applied to the user device, causing the user to join the first conference using the user device applying the first modality setting.

10. The method of claim 9, further comprising:
receiving a second user input indicating an intention of the user to modify the first modality setting or switch to a second modality setting stored in the data storage;
in response to receiving the second user input, rendering a modality setting user interface;
receiving, via the modality setting user interface, a third user input to modify the first modality setting or switch to the second modality setting; and
in response to receiving the third second user input, modifying the first modality setting or switching to the second modality setting.

11. The method of claim 9, further comprising receiving the first modality setting from a remote device via a communication network.

12. The method of claim 9, further comprising:
rendering a modality setting user interface; and
receiving, via the modality setting user interface, a second user input to set up the first modality setting.

13. The method of claim 9, further comprising:
storing a second modality setting comprising a plurality of second predetermined conference-related functionality settings applicable to the user device, the second modality setting corresponding to a second preset conference condition prescribing another conference attribute;
receiving a second user input indicating an intention of the user to join a second conference;
in response to receiving the second user input, determining, based on an attribute of the second conference and the prescribed conference attributes of the first and second preset conference conditions, determining that the second conference meets the second preset conference condition;
in response to determining that the second conference meets the second preset conference condition, automatically causing the stored second modality setting to be applied to the user device; and
in response to the second modality setting being applied to the user device, causing the user to join the second conference using the user device applying the second modality setting.

14. The method of claim 9, wherein the first modality setting defines at least one of:
whether a video representation is to be turned on or off;
whether a video filter is to be applied or not;
whether a microphone is to be turned on or off;
whether a speaker is to be turned on or off; and
which audio and visual devices are to be used.

15. The method of claim 9, wherein the first modality setting defines:
whether to join the first conference without enabling audio and video capabilities;
whether to join the first conference via a public switched telephone network (PSTN) for audio content of the first conference; and
whether to join the first conference at a designated conference location while accessing audio and video content of the first conference via the device.

16. The method of claim 9, wherein the attribute of the first conference comprises at least one of a conference series identification, conference participants and conference type.

17-20. (canceled)

21. The device of claim 1, wherein the user device comprises the device.

22. The device of claim 1, wherein the user device is a remote device in communication with the device via a communication network.

23. The method of claim 9, wherein the user device comprises the device.

24. The method of claim 9, wherein the user device is a remote device in communication with the device via a communication network.
